(19) United States
(12) Patent Application Publication
(10) Pub. No.: US 2026/0322196 A1
(43) Pub. Date: Oct. 15, 2026

(54) ROTOR FOR ELECTRIC MOTOR AND METHOD OF MANUFACTURE

(71) Applicant: GHSP, INC., Holland, MI (US)

(72) Inventors: Andrew Kevin Even, Grand Haven, MI (US); Ryan David Rosinski, Whitehall, MI (US)

(73) Assignee: GHSP, INC., Holland, MI (US)

(21) Appl. No.: 19/629,257

(22) Filed: Mar. 26, 2026

Related U.S. Application Data
(60) Provisional application No. 63/786,569, filed on Apr. 10, 2025.

(51) Int. Cl. H02K 1/28; H02K 1/278; H02K 15/035; H02K 15/12; H02K 21/16

(52) U.S. Cl. CPC H02K 1/28; H02K 1/278; H02K 15/035; H02K 15/12; H02K 21/16

(57) ABSTRACT

A rotor for an electric motor includes a metallic core having a plurality of magnet receptacles defined within an outer surface of the metallic core, a plurality of magnets that are disposed within the magnet receptacles, respectively, where each magnet of the plurality of magnets has opposing angled edges, and a plastic securing layer that is injection molded between the opposing angled edges and the metallic core. The plastic securing layer engages each of the magnet receptacles, the opposing angled edges and the outer surface of the metallic core.

### CROSS-REFERENCE TO RELATED APPLICATION

This application claims priority to and the benefit under 35 U.S.C. § 119(e) of U.S. Provisional Patent Application No. 63/786,569, filed on Apr. 10, 2025, entitled ROTOR FOR ELECTRIC MOTOR AND METHOD OF MANUFACTURE, the entire disclosure of which is hereby incorporated herein by reference.

### FIELD OF THE DISCLOSURE

The present disclosure generally relates to electric motors, and more specifically, a rotor for an electric motor that incorporates a plastic securing layer that secures magnets to a metallic core while leaving portions of the magnets exposed to a stator that surrounds the rotor or is positioned within the rotor.

### BACKGROUND OF THE DISCLOSURE

Within electric motors, a rotor rotationally operates relative to a stator. The stator includes windings that are energized to produce an electromagnetic field. A magnetic component within the rotor interacts with the electromagnetic field to produce an electromotive force that rotates the rotor with respect to the stator to rotate the mechanical component. The rotor can be disposed within the stator or can surround the stator.

### SUMMARY OF THE DISCLOSURE

According to one aspect of the present disclosure, a rotor for an electric motor includes a metallic core having a plurality of magnet receptacles defined within an outer surface of the metallic core, a plurality of magnets that are disposed within the magnet receptacles, respectively, where each magnet of the plurality of magnets has opposing angled edges, and a plastic securing layer that is injection molded between the opposing angled edges and the metallic core. The plastic securing layer engages each of the magnet receptacles, the opposing angled edges and the outer surface of the metallic core.

According to another aspect of the present disclosure, an electric motor includes a stator having a winding that is selectively energized to produce an electromagnetic field within a rotor cavity defined within an interior of the stator, and a rotor disposed within the rotor cavity. The rotor includes a metallic core having magnet receptacles defined within an outer surface of the metallic core, magnets that are disposed within the magnet receptacles, respectively, where each of the magnets has opposing angled edges, and a plastic securing layer that is injection molded to the outer surface and between the magnets. The plastic securing layer extends partially into the magnet receptacles to secure the magnets within the magnet receptacles. The plastic securing layer engages the opposing angled edges of the magnets. Further, outward facing surfaces of the magnets are exposed within the rotor cavity proximate the winding.

According to another aspect of the disclosure, a method of assembling a rotor includes steps of forming a metallic core having magnet receptacles defined within an outer surface of the metallic core, disposing magnets within the magnet receptacles of the metallic core, placing the metallic core and the magnets into a mold that defines molding cavities against outer edges of the magnets, and injection molding a plastic securing layer into the molding cavities to locate a molding material between angled surfaces of the magnets to secure the plastic securing layer and the magnets to the metallic core. Outward facing surfaces of the magnets are exposed through the plastic securing layer.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a rotor that includes an aspect of the plastic securing layer that secures the magnets to the metallic core;

FIG. 2 is a cross-sectional view of the rotor of FIG. 1 taken along line II-II;

FIG. 3 is an enlarged cross-sectional view of the rotor of FIG. 2 taken at area III;

FIG. 4 is a cross-sectional view of an exemplary electric motor that incorporates the rotor disposed within a stator of FIG. 1; and

FIG. 5 is a linear flow diagram illustrating a method for manufacturing a rotor for an electric motor.

The components in the figures are not necessarily to scale, emphasis instead being placed upon illustrating the principles described herein.

### DETAILED DESCRIPTION

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

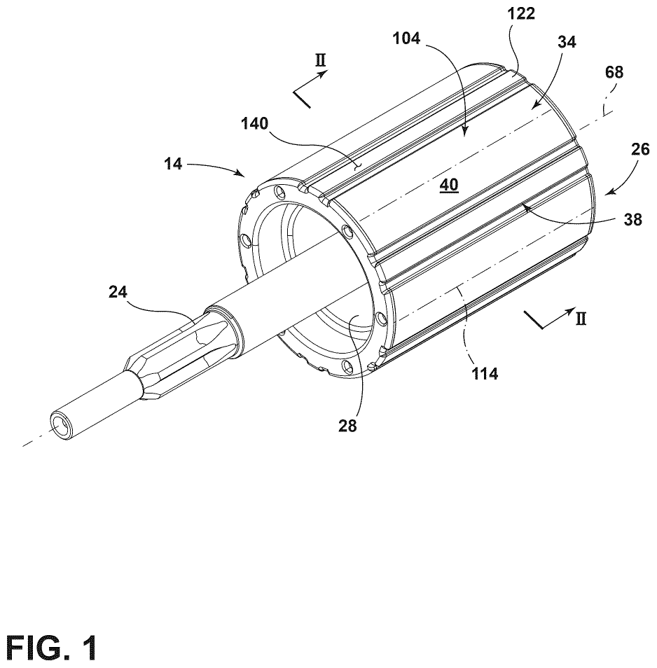

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a rotor for an electric motor that incorporates a plastic securing layer that secures magnets to a metallic core while leaving portions of the magnets exposed to a stator that surrounds the rotor. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

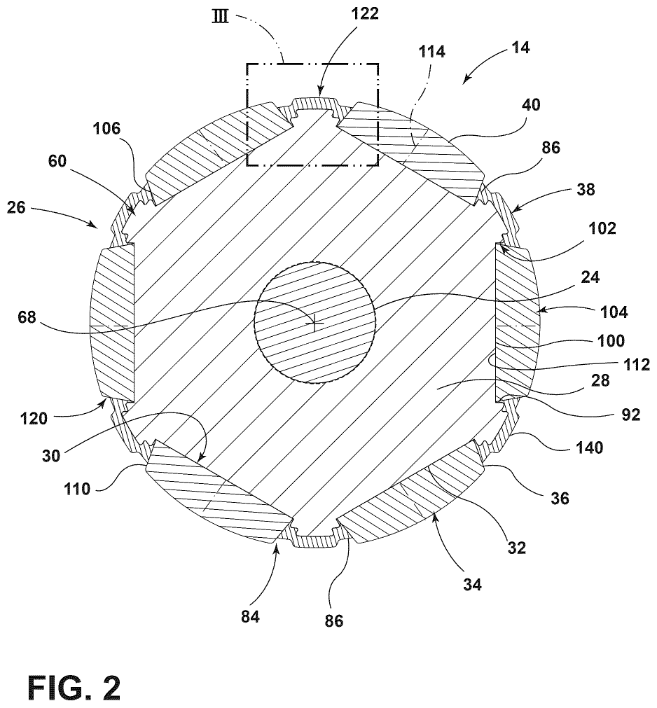

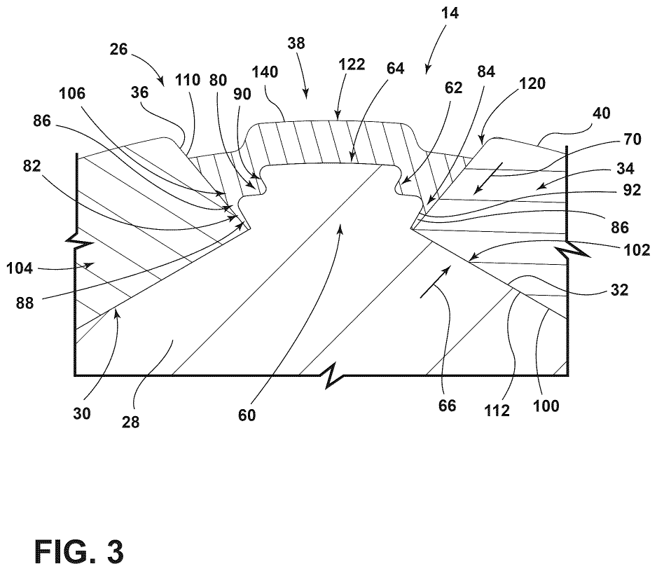

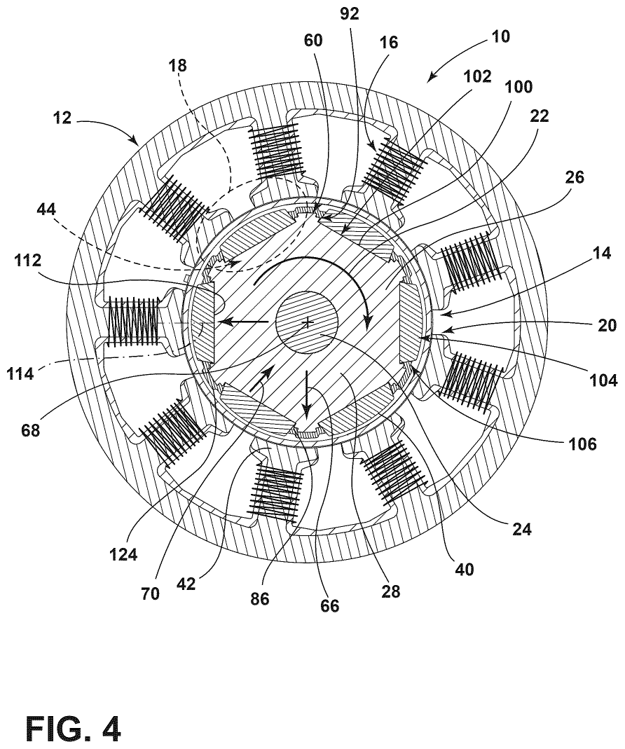

Referring to FIGS. 1-4, reference numeral 10 generally refers to an electric motor that includes a stator 12 and a rotor 14 that operates with respect to the stator 12. According to the various aspects of the device, electric motor 10 includes the stator 12 having at least one winding 16, where the winding 16 is selectively energized to produce an electromagnetic field 18. The electromagnetic field 18 is produced within a rotor cavity 20 defined within an interior of the stator 12. The rotor 14 is disposed within the rotor cavity 20 and interacts with the electromagnetic field 18 of the stator 12 to produce an electromotive force 22 that rotates the rotor 14 within the rotor cavity 20. The rotor 14 includes a rotor shaft 24 and a body 26. The body 26 includes a metallic core 28 having magnet receptacles 30 defined within an outer surface 32 of the metallic core 28. Magnets 34 are disposed within the magnet receptacles 30, respectively. The magnets 34 include opposing angled edges 36. A plastic securing layer 38 is injected molded to the metallic core 28 and between the angled edges 36 of adjacent magnets 34. The plastic securing layer 38 extends partially into the magnet receptacles 30 to secure the magnets 34 within the magnet receptacles 30. The plastic securing layer 38 engages the opposing angled edges 36 of the magnets 34 to secure the magnets 34 within the magnet receptacles 30. Outward facing surfaces 40 of the magnets 34 are exposed through the plastic securing layer 38, within the rotor cavity 20, proximate teeth 42 of the stator 12 around which the windings 16 are disposed. Through this configuration, the magnets 34 of the rotor 14 can be positioned in close proximity to the windings 16 and the teeth 42 of the stator 12 for maximizing the interaction between the respective magnetic fields 44 of the magnets 34 and the electromagnetic field 18 produced by the windings 16 of the stator 12.

Referring again to FIGS. 1-4, the metallic core 28 includes the magnet receptacles 30. The metallic core 28 also includes retaining portions 60 that are positioned between the adjacent magnets 34. In this manner, the magnet receptacles 30 are partially defined by the retaining portions 60. These retaining portions 60 each include inwardly angled channels 62 that receive a portion of the plastic securing layer 38. In this manner, the retaining portions 60 define one or more reverse dovetail profiles 64 that secure the plastic securing layer 38 to the outer surface 32 of the metallic core 28 of the rotor 14. In this manner, the inwardly angled channels 62 receive a portion of the plastic securing layer 38 and provide an interference fit between the metallic core 28 and the plastic securing layer 38. As the rotor 14 rotates about a rotational axis 68 of the rotor 14, a centrifugal force 66 is produced that outwardly biases the magnets 34 and the plastic securing layer 38 away from the rotational axis 68 of the rotor 14 and away from the outer surface 32 of the metallic core 28. The configuration of the retaining portions 60 having the reverse inwardly angled channels 62 of the reverse dovetail profile 64 provides and exerts a centripetal force 70 that opposes and negates the centrifugal force 66 to secure the magnets 34 within the magnet receptacles 30. The centripetal force 70 is also generated by the retaining portions 60 to prevent the plastic securing layer 38 from moving outward and under the centrifugal force 66 produced by the rotation of the rotor 14. Stated another way, the retaining portions 60 secure the plastic securing layer 38 to the metallic core 28 of the rotor 14, and, in turn, secures the magnets 34 within the magnet receptacles 30.

According to various aspects of the device, the retaining portions 60 of the metallic core 28 can include a plurality of the inwardly angled channels 62. An outer set 80 of inwardly angled channels 62 defines an outer reverse dovetail profile 90. Similarly, an inner set 82 of the inwardly angled channels 62 defines an inner reverse dovetail profile 88. Each of the outer reverse dovetail profile 90 and the inner reverse dovetail profile 88 secure the plastic securing layer 38 to the metallic core 28. Additionally, the inner set 82 of the inwardly angled channels 62 are used to partially define sidewalls 92 of the magnet receptacles 30. In this manner, the inner set 82 of inwardly angled channels 62 are used to retain the plastic securing layer 38 and the magnets 34 within the magnet receptacles 30.

According to the various aspects of the device, as exemplified in FIGS. 1-4, the inner set 82 of the inwardly angled channels 62 form the sidewalls 92 of adjacent magnet receptacles 30. These sidewalls 92 of the magnet receptacles 30 are positioned to be generally perpendicular to a receiving wall 100 of a corresponding magnet receptacle 30. In this manner, the receiving wall 100 and the sidewalls 92 of a particular magnet receptacle 30 form a generally rectilinear recess 102 defined within the outer surface 32 of the metallic core 28 for the rotor 14. As described herein, the magnet 34, having a trapezoidal prism shape 104, is disposed within the magnet receptacle 30. The combination of the trapezoidal prism shape 104 of the magnet 34 and the rectilinear recess 102 of the magnet receptacle 30 forms the spaces 84 that are defined between the magnets 34 and the outer surface 32 of the metallic core 28. When the plastic securing layer 38 is disposed within these spaces 84, this portion of the plastic securing layer 38 defines interference portions 106 on the plastic securing layer 38. These interference portions 106 have a generally wedge-shaped configuration that engages each of the inner set 82 of the inwardly angled channels 62, or sidewalls 92 of the magnet receptacles 30, as well as the opposing angled edges 36 of the magnets 34. This wedge shape of the interference portions 106 for the plastic securing layer 38 prevents the outward movement of each of the magnets 34 during rotation of the rotor 14 about the rotational axis 68. Through this configuration, the reverse dovetail profiles 64 of the retaining portions 60 positioned between the magnet receptacles 30 holds and secures the plastic securing layer 38 in place. The plastic securing layer 38 forms the interference portions 106 that, in turn, hold the magnets 34 in place.

During assembly of the rotor 14, a space 84 is formed between the opposing angled edges 36 of the magnets 34 and the inner set 82 of the inwardly angled channels 62 of the retaining portions 60 for the metallic core 28. This inner set 82 of the inwardly angled channels 62 defines a secondary reverse dovetail profile 64 that further retains the plastic securing layer 38 to the outer surface 32 of the metallic core 28. Using these multiple sets of the inwardly angled channels 62, the plastic securing layer 38 is retained through multiple interference mechanisms against the outer surface 32 of the metallic core 28. Additionally, the portion of the plastic securing layer 38 that is within the inner set 82 of the inwardly angled channels 62 occupies the space 84 between the metallic core 28 and the angled surfaces 110 defined by the opposing edges 36 of the magnets 34 to form a wedge 86. This wedge 86 formed by the plastic securing layer 38 forms a securing mechanism that secures the plastic securing layer 38 in place, and, in turn, secures the magnets 34 within the respective magnet receptacles 30.

According to the various aspects of the device, as exemplified in FIGS. 1-4, the opposing angled edges 36 of each magnet 34 are angled from a back side 112 and toward a centerline 114 of the magnet 34. Generally, the opposing angled edges 36 are in an oblique orientation with respect to the back side 112 of the magnet 34. In particular, the oblique angle of the angled edges 36 can be within a range of from approximately 85 degrees to approximately 75 degrees relative to the back side 112 of the magnet 34. It is also contemplated that the oblique angle of the angled edges 36 can be from approximately 85 degrees to approximately 65 degrees relative to the back side 112 of the magnet 34. In this manner, each magnet 34 generally forms a trapezoidal prism shape 104 that can be placed within respective magnet receptacles 30. As described herein, the trapezoidal prism shape 104 of each magnet 34, in combination with a rectilinear recess 102 of each magnet receptacle 30, forms the space 84 into which the plastic securing layer 38 can be positioned in order to secure each magnet 34 within a respective magnet receptacle 30. Additionally, because the rectilinear recesses 102 are positioned about the outer surface 32 of the metallic core 28 for the rotor 14, the sidewalls 92 of the rectilinear recesses 102 cooperate to form a portion of the reverse dovetail profile 64 that are defined between adjacent magnet receptacles 30 of the plurality of magnet receptacles 30.

Referring again to FIGS. 1-4, the plastic securing layer 38 engages the opposing edges 36 of the plurality of magnets 34. As described herein, the opposing edges 36 of the plurality of magnets 34 each includes an angled surface 110 that forms the space 84 within which the wedge 86 of the plastic securing layer 38 is formed. The interaction between the plastic securing layer 38, the retaining portions 60 of the metallic core 28, and the angled surfaces 110 of the opposing edges 36 of each of the magnets 34 provides a cooperative securing mechanism that retains the magnets 34 within the magnet receptacles 30 of the metallic core 28.

As described herein, rotation of the rotor 14 occurs at a high rate of speed such that a significant centrifugal force 66 is produced. Use of the plastic securing layer 38 with respect to each retaining portion 60 of the metallic core 28 provides interlocking engagements with respect to the inner set 82 of inwardly angled channels 62 and the angled surfaces 110 of the opposing edges 36 of the magnets 34 to secure the magnets 34 in place.

Referring again to FIGS. 1-4, the rotor 14 for the electric motor 10 includes the metallic core 28 having the plurality of magnet receptacles 30 defined with the outer surface 32 of the metallic core 28. The plurality of magnets 34 are disposed within the magnet receptacles 30, respectively. The plurality of magnets 34 include angled shutoffs 120 in the form of the angled surfaces 110 of the opposing edges 36. These angled shutoffs 120 are respectively defined within the opposing edges 36 of each magnet 34 of the plurality of magnets 34. The plastic securing layer 38 is injected molded between the angled shutoffs 120 of adjacent magnets 34 of the plurality of magnets 34. The plastic securing layer 38 engages each of the magnet receptacles 30 and the angled shutoffs 120 of the plurality of magnets 34. In this manner, the plastic securing layer 38 forms a plurality of frames 122 that surround each of the magnets 34, thereby exposing the outward facing surfaces 40 of the magnets 34 to inward facing surfaces 124 of the various teeth 42 of the stator 12. As described herein, because the outward facing surfaces 40 of the magnets 34 are exposed, there is a close engagement between the magnets 34 of the rotor 14 and the electromagnetic field 18 produced by the windings 16 of the stator 12. Typically, the outward facing surfaces 40 of each of the magnets 34 are curved in a manner that is concentric about the rotational axis 68 of the rotor 14. This curved configuration of the exposed outward facing surfaces 40 of the magnets 34 can also be concentric relative to the inward facing surfaces 124 if the teeth 42 of the stator 12, thereby creating a close engagement between the exposed outward facing surfaces 40 of the magnets 34 and the inward facing surfaces 124 if the teeth 42 of the stator 12.

Referring again to FIGS. 1-4, the angled surfaces 110 that form the angled shutoffs 120 of the magnets 34 are within a range of from approximately 5° to approximately 20°. Typically, the angled shutoffs 120 of the opposing edges 36 of the magnets 34 are within a range of from approximately 8° to approximate 12°. It is also typical that the angled shutoffs 120 of the opposing edges 36 of each of the magnets 34 can be approximately 10°.

According to the various aspects of the device, the angles defined by the inwardly angled channels 62 of the retaining portions 60 of the metallic core 28 define different angles as compared to the angles of the angled surfaces 110 of the shutoffs 120 to the magnets 34. This dissimilarity among these angles produces the receiving space 84 within which the injected molded plastic material can be disposed for forming the wedge 86 of the plastic securing layer 38 that retains the magnets 34 within the magnet receptacles 30 of the metallic core 28.

As described herein, the plastic securing layer 38 forms a plurality of frames 122 that surround the various magnets 34 of the rotor 14. Adjacent frames 122 that surround a particular magnet 34 engage the angled shutoffs 120 of the opposing edges 36 of the magnets 34. Because the magnets 34 angle inward toward the outward facing surface 40, the plastic securing layer 38 covers at least a portion of the opposing edges 36 to prevent outward movement of the magnet 34 relative to the magnet receptacles 30. Stated another way, the frames 122 that are formed by the plastic securing layer 38 form a blocking feature that prevents movement of the magnet 34 away from the magnet receptacles 30 and also secures the magnet 34 within the respective magnet receptacles 30.

The design of the rotor 14 that includes the exposed outward facing surfaces 40 of the magnets 34 achieves a smaller mechanical air gap between the stator 12 and the external surface 140 of the rotor 14. More specifically, the air gap between the outward facing surface 40 of the magnets 34 and the inward facing surface 124 of the stator 12 is able to be smaller using the rotor 14 described herein. This smaller air gap is accomplished through eliminating the plastic layer that typically surrounds the outward facing surfaces 40 of the magnets 34 within conventional rotors 14. Removing this portion of the plastic overmold, the outward facing surfaces 40 of the magnets 34 are exposed to provide for a smaller gap between the rotor 14 and the stator 12. Additionally, the plastic securing layer 38 defines the primary securing force that secures the magnets 34 to the magnet receptacles 30 of the metallic core 28. This interaction eliminates the need for glue or other adhering features to secure the magnets 34 to the metallic core 28.

According to the various aspects of the device, the studies of the design of the rotor 14, as described herein, have shown that the rotor 14 can be made with a smaller overall diameter of approximately 1.4 mm without diminishing performance of the rotor 14 within the stator 12. Accordingly, less material is needed with respect to the plastic overmold, as well as the metallic core 28 for producing the rotor 14 that operates within the stator 12. Additionally, because the rotor 14 can be decreased in size, and the air gap between the rotor 14 and stator 12 can be diminished, the overall size of the stator 12 can also be decreased, without diminishing performance of the rotor 14 within the stator 12.

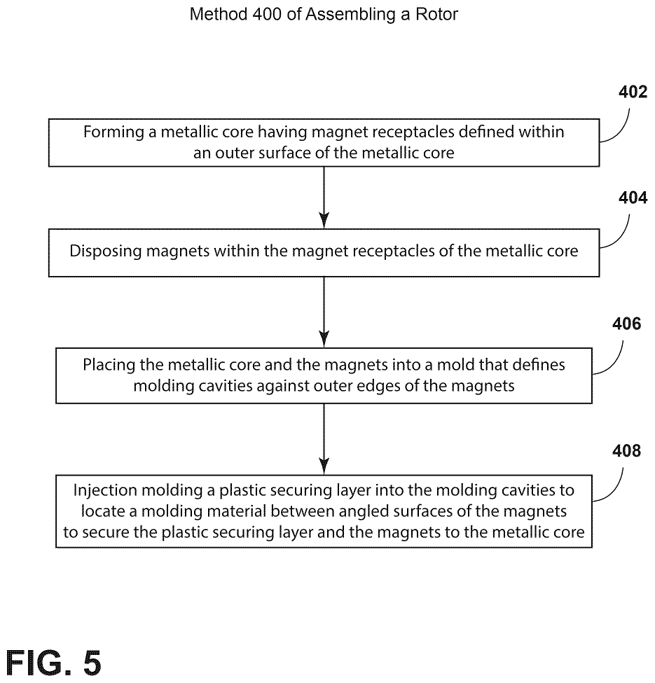

Referring now to FIGS. 1-5, having described various aspects of the device, a method 400 is disclosed for assembling a rotor 14 for an electric motor 10. The method 400 includes a step 402 of forming a metallic core 28 having magnet receptacles 30 defined therein. According to the method 400, a step 404 includes disposing magnets 34 within the magnet receptacles 30 of the metallic core 28. After the magnets 34 are disposed within the magnet receptacles 30, the metallic core 28 with the magnets 34 placed within the magnet receptacles 30 is disposed into a mold that forms molding cavities that partially define the spaces 84 between the magnets 34 and the retaining portions 60 of the metallic core 28 (step 406). These molding cavities are also defined by the retaining portions 60 of the metallic core 28. Once in the mold, a plastic securing layer 38 is formed by injecting a plastic molding material into the molding cavities that are defined around the magnets 34, and between the angled surfaces 110 defined by the opposing edges 36 of the magnets 34 and onto retaining portions 60 of the metallic core 28 (step 408). The plastic securing layer 38 engages the inwardly angled channels 62 of the magnet receptacles 30 to secure the plastic securing layer 38 to the magnets 34 as well as securing the plastic securing layer 38 to the metallic core 28.

Referring to FIG. 1-4, the illustrated aspect of the device is that of an electric motor 10 having an inner-rotor configuration, where the rotor 14 is disposed and rotationally operates within a rotor cavity 20 of the stator 12. It is also contemplated that the aspects of the device, as disclosed herein, can be applied to an outer-rotor configuration electric motor 10, and the manufacture thereof.

According to the various aspects of the device, the design of the rotor 14, as described herein, provides for an efficient method of manufacture that provides for a higher degree of performance by exposing the outward facing surfaces 40 of the magnets 34 to the inward facing surfaces 124 of the stator 12. Additionally, the plastic securing layer 38 forms the frames 122 that surround the magnets 34 and secure the magnets 34 to the metallic core 28. Through this configuration, the rotor 14 can operate the rotor shaft 24 as well as a functional piece of equipment attached to the rotor 14 with greater efficiency and using less electricity for powering the rotor 14 with respect to the stator 12.

It will be understood by one having ordinary skill in the art that construction of the described disclosure and other components is not limited to any specific material. Other exemplary embodiments of the disclosure disclosed herein may be formed from a wide variety of materials, unless described otherwise herein.

What is claimed is:

1. A rotor for an electric motor, the rotor comprising:
a metallic core having a plurality of magnet receptacles defined within an outer surface of the metallic core;
a plurality of magnets that are disposed within the magnet receptacles, respectively, each magnet of the plurality of magnets having opposing angled edges; and
a plastic securing layer that is injection molded between the opposing angled edges and the metallic core, wherein the plastic securing layer engages each of the magnet receptacles, the opposing angled edges and the outer surface of the metallic core.

2. The rotor of claim 1, wherein the opposing angled edges of the plurality of magnets are obliquely angled toward a centerline of each respective magnet relative to a back side of each respective magnet.

3. The rotor of claim 1, wherein the magnet receptacles include retaining portions that are positioned between adjacent magnets of the plurality of magnets, the retaining portions each including inwardly angled channels that receive interference portions of the plastic securing layer.

4. The rotor of claim 3, wherein the inwardly angled channels of adjacent magnet receptacles of the plurality of magnet receptacles define reverse dovetail profiles that receive the interference portions of the plastic securing layer.

5. The rotor of claim 4, wherein engagement of the interference portions with the reverse dovetail profiles secures the engagement of the plastic securing layer with the metallic core and further secures the engagement of the plurality of magnets with the magnet receptacles.

6. The rotor of claim 1, wherein the plastic securing layer engages the opposing angled edges of the plurality of magnets, and wherein respective outward facing surfaces of the plurality of magnets are exposed through the plastic securing layer.

7. The rotor of claim 5, wherein the engagement of the interference portions and the reverse dovetail profiles exerts a centripetal force on the plurality of magnets that at least partially secures the magnets within the magnet receptacles.

8. The rotor of claim 4, wherein the magnet receptacles include a receiving wall and sidewalls that are generally perpendicular to the receiving wall.

9. The rotor of claim 8, wherein the sidewalls of adjacent magnet receptacles partially define the reverse dovetail profiles.

10. The rotor of claim 9, wherein the retaining portions of the metallic core are defined between the adjacent magnet receptacles, wherein the retaining portions include an inner reverse dovetail profile and an outer reverse dovetail profile of the reverse dovetail profiles.

11. The rotor of claim 4, wherein the magnet receptacles define generally rectilinear recesses within the metallic core, and wherein the rectilinear recesses cooperate to define the reverse dovetail profiles that are defined between adjacent magnet receptacles of the plurality of magnet receptacles.

12. An electric motor comprising:
a stator having a winding that is selectively energized to produce an electromagnetic field within a rotor cavity defined within an interior of the stator; and
a rotor disposed within the rotor cavity, the rotor comprising:
a metallic core having magnet receptacles defined within an outer surface of the metallic core;
magnets that are disposed within the magnet receptacles, respectively, each of the magnets having opposing angled edges; and
a plastic securing layer that is injection molded to the outer surface and between the magnets, the plastic securing layer extending partially into the magnet receptacles to secure the magnets within the magnet receptacles, wherein the plastic securing layer engages the opposing angled edges of the magnets, and wherein outward facing surfaces of the magnets are exposed within the rotor cavity proximate the winding.

13. The electric motor of claim 12, wherein the magnet receptacles include retaining portions that are positioned between adjacent magnets, the retaining portions each including inwardly angled channels that receive interference portions of the plastic securing layer.

14. The electric motor of claim 13, wherein the inwardly angled channels of adjacent magnet receptacles of the plurality of magnet receptacles define reverse dovetail profiles that receive the interference portions of the plastic securing layer.

15. The electric motor of claim 14, wherein engagement of the interference portions with the reverse dovetail profiles secures the engagement of the plastic securing layer with the metallic core and further secures the engagement of the magnets with the magnet receptacles, respectively.

16. The electric motor of claim 15, wherein the engagement of the interference portions and the reverse dovetail profiles exerts a centripetal force on the magnets that at least partially secures the magnets within the magnet receptacles.

17. The electric motor of claim 14, wherein the magnet receptacles include a receiving wall and sidewalls that are generally perpendicular to the receiving wall, and wherein the sidewalls of adjacent magnet receptacles partially define the reverse dovetail profiles.

18. The electric motor of claim 17, wherein retaining portions of the metallic core are defined between the adjacent magnet receptacles, wherein the retaining portions include an inner reverse dovetail profile and an outer reverse dovetail profile of the reverse dovetail profiles.

19. The electric motor of claim 14, wherein the magnet receptacles define generally rectilinear recesses within the metallic core, and wherein the rectilinear recesses cooperate to define the reverse dovetail profiles that are defined between adjacent magnet receptacles of the plurality of magnet receptacles.

20. A method of assembling a rotor, the method comprising steps of:
forming a metallic core having magnet receptacles defined within an outer surface of the metallic core;
disposing magnets within the magnet receptacles of the metallic core;
placing the metallic core and the magnets into a mold that defines molding cavities against outer edges of the magnets; and
injection molding a plastic securing layer into the molding cavities to locate a molding material between angled surfaces of the magnets to secure the plastic securing layer and the magnets to the metallic core, wherein outward facing surfaces of the magnets are exposed through the plastic securing layer.
